(19) United States
(12) Patent Application Publication
(10) Pub. No.: US 2010/0257084 A1
(43) Pub. Date: Oct. 7, 2010

(54) METHOD OF PROVIDING AN INCENTIVE SAVINGS ACCOUNT

(75) Inventors: Andrea Tittel, Boston, MA (US); Geoff Thomas, Needham, MA (US); Andrew Faulkner, Barrington, RI (US); William Koleszar, Walpole, MA (US)

Correspondence Address: BARLOW, JOSEPHS & HOLMES, LTD., 101 DYER STREET, 5TH FLOOR, PROVIDENCE, RI, 02903, US

(73) Assignee: CITIZENS FINANCIAL GROUP, INC., Providence, RI (US)

(21) Appl. No.: 12/416,696

(22) Filed: Apr. 1, 2009

(51) Int. Cl. G06Q 40/00; G06Q 30/00

(52) U.S. Cl. 705/35; 705/14.66

(57) ABSTRACT

A method and system for establishing a savings account for the benefit of an account holder is provided wherein the account holder arranges to make periodic deposits into the savings account and the bank service provider deposits an predetermined incentive amount into the account such that the account holder can access the incentive amount after a fixed period of time or after a fixed savings goal is reached. In one embodiment, the method and system of the present invention tailored for use in connection with a savings account that is established as a college savings account for the benefit of a child. The method and system is also applicable in other contexts such as for example, retirement savings, education savings, healthcare savings, home purchase savings, etc.

### BACKGROUND OF THE INVENTION

The present invention relates generally to a system and method for establishing and administering a savings plan that offers incentives bonuses to customers that participate in the plan. More specifically, the present invention relates to a savings plan program wherein a bank service provider establishes a savings account for the benefit of an account holder, the account holder arranges to make periodic deposits into the savings account and the bank service provider deposits an predetermined incentive amount into the account such that the account holder can access the incentive amount after a fixed period of time or once an established goal is reached.

It is well known that nobody feels like they are saving enough money. In fact, there are frequent news stories that underscore the fact that the savings rate in the United States is actually a negative value meaning that most households are actually spending more money than they are taking in. Further, families are facing increasing incremental expenses in their day-to-day lives. This can be seen in their inability to accumulate money for important goals in their lives such as paying for a child's college education or purchasing a home. Families are facing increased pressure as the incremental cost related to raising their children and maintaining a household continues to spiral upwardly. For example, tuition costs for educating children has risen nearly 10-fold in the past thirty years. It is therefore not surprising that most consumers feel that saving money is a difficult process. At all levels of income consumers find it challenging to meet a savings goal such as putting money away for emergencies, for a child's education, for a rainy day emergency or just for a special purchase, such as a home.

Generally in the prior art, the typical vehicle available to a consumer to facilitate savings is a traditional savings account. By establishing a savings account, a consumer can save funds into the account by making deposits directly or by transferring funds from another account. Further, they can automate the savings function by setting up recurring transfers from another account. The difficulty is that, the recurring transfer function is limited by a requirement that the user must set a specific transfer amount and the fact that the transfer must occur on a particular schedule. While such recurring transfers can be helpful, the only incentive for a user to make such deposits is the positive feeling received as the savings balance grows and any interest earned on the account. As a result, as other financial demands in life overwhelm the user, it is likely that the recurring savings deposits will be terminated since the incentive to make the deposits is not strong enough to balance against the other financial demands faced by the user.

The difficulty with the traditional savings model of the prior art is that it does not provide sufficient structure or require the necessary discipline. Without a requirement for a disciplined approach or an incentive to motivate the customer, frequently the customer never even takes the first step along the path towards the goal. As a result, the customer is overwhelmed by the magnitude of the future goal and dismisses it at a plan that simply will not work or a plan that they will have to wait until later to implement.

Based on the above-described issues related to conventional savings methods, there is a need for a system and method for establishing and maintaining a structured and disciplined approach to savings while providing an incentive that is sufficient to get the user excited about saving. Further, there is a need for a method and system of administering an incentive savings account that provides a large award that is keyed to disciplined behavior on the part of customer. Still further there is a need for a method and system of administering an incentive savings account that offers an incentive that is tied to a predetermined goal while preventing user access to those funds for a predetermined period of time.

### BRIEF SUMMARY OF THE INVENTION

In this regard, the present invention provides a method and system of administering an incentive savings account that operates in a manner that gets the customer excited about saving in a disciplined fashion by offering a substantial incentive for using the savings account in the prescribed manner. Through the use of the incentive program, the customer is jumpstarted towards their savings goal in that the balance in the account will reflect an incentive award provided the customer maintains the disciplined savings behavior over a stated period of time. This encourages the customer to begin making smaller periodic deposits in the account while still having the feeling that the deposits are actually adding up to an amount of money that can actually make a difference in their life or towards a specific savings goal.

According to the most general terms of the present invention the method provides for a bank service provider to establish a savings account for the benefit of an account holder, the account holder arranges to make periodic deposits into the savings account and the bank service provider deposits an predetermined incentive amount into the account such that the account holder can access the incentive amount after a fixed period of time or after a fixed savings goal is reached. In one embodiment, the method and system of the present invention tailored for use in connection with a savings account that is established as a college savings account for the benefit of a child. In this regard, the user must seek to establish the savings account within six years of the child's birth. An incentive amount is tagged to the account and the incentive along with accrued interest is deposited once the child reaches 18 years of age and the customer has met all of the eligibility requirements,

In addition, the method and system of the present invention is applicable in other contexts such as for example, retirement savings, education savings, healthcare savings, home purchase savings, etc. In the context of a home purchase embodiment, for example, a customer establishes a savings account and agrees to deposit a fixed monthly amount for a predetermined period of time. Once the customer completes the agreed upon deposit term, they are given an incentive in the form of a closing cost credit for use with the bank service provider. It is of note that in each of these other contexts, the amount of the initial deposit and/or the length of time for which access to the initial deposit amount may vary although the underlying inventive concept will remain the same.

Accordingly, it is an object of the present invention to provide a system and method for establishing and maintaining a structured and disciplined approach to savings while providing an incentive that is sufficient to get the user excited about saving. Further, it is an object of the present invention to provide a method and system of administering an incentive savings account that provides a large award that is keyed to disciplined behavior on the part of customer. Still further it is an object of the present invention to provide a method and system of administering an incentive savings account that offers an incentive that is tied to a predetermined goal while preventing user access to those funds for a predetermined period of time.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### DETAILED DESCRIPTION OF THE INVENTION

Now turning to the method and system of the present invention in detail. As can be understood, the present invention most generally provides a method and system of administering an incentive savings account that operates in a manner gets the customer excited about saving in a disciplined fashion by offering a substantial incentive for using the savings account in the prescribed manner. In operation, a bank service provider establishes a savings account for the benefit of an account holder, the account holder arranges to make periodic deposits into the savings account and the bank service provider deposits an predetermined incentive amount into the account such that the account holder can access the incentive amount after an initial condition is met. During the period of the offer the bank service provider may or may not offer interest on the account balance, the incentive amount and/or both. Such an initial condition may be a fixed period of time or based upon meeting a fixed savings goal.

In a first one embodiment, the method and system of the present invention tailored for use in connection with a savings account that is established as a college savings account for the benefit of a child. In this regard, the customer, through a bank service provider, establishes a savings account within six years of the child's birth. The customer agrees to make regular periodic deposits into the account from the time the account is established until the child reaches a predetermined age. In turn, the bank service provider identifies an incentive amount that will be attributed to the account and the incentive and accrued interest is deposited to the account such that it is available once the child reaches the predetermined age and the customer has met all of the eligibility requirements. Alternately, should the customer not continue to make the agreed upon deposits or should the customer withdraw the balance from the account, the present invention also provides for the customer to forfeit the incentive amount and any interest accrued thereon. In this manner, the incentive works both as positive reinforcement as well as a punitive measure should the customer stop participating in the program before meeting the set conditions.

While one embodiment is described above relating to a savings account for a child, it should be appreciated that, there are many other contexts to which the method and system of the present invention may apply. For example, the present invention may be implemented in other contexts such as, retirement savings, education savings, healthcare savings, home purchase savings, etc. Further, while the present invention has been described in terms of a traditional savings account, it is also anticipated that the method and system of the present invention is equally applicable to any other type of account including but not limited to money market accounts, certificates of deposit, college savings vehicles such as 529 plans and Coverdell savings accounts, scholarship funds and retirement vehicles such as IRAs and Roth IRAs. Further, while a single incentive is described above, it is also possible that milestones be set in the context of the account term that allow for multiple incentives to be deposited by the bank service provider should the conditions of the predetermined milestones be met. It is of note that in each of these varying contexts, the amount of the incentive deposit and/or the length of time for which access to the incentive deposit amount may vary although the underlying inventive concept will remain the same.

In an alternate embodiment, the method and system of the present invention works equally well in connection with saving to make a home purchase. In this embodiment, a customer establishes a savings account with a bank service provider and agrees to deposit a fixed monthly amount for a predetermined period of time. Once the customer completes making the regular deposits for the entire agreed upon deposit term, they are given an incentive in the form of a credit towards closing costs when making a home purchase with a loan from the bank service provider. In connection with this particular embodiment, the bank service provider may arrange for the customer to pre-qualify for a mortgage loan near the end of the predetermined period of time so that the customer knows how large a down payment they will need to save and how much house they can afford. Further, through a regular pattern of savings such as provided in the context of the method and system of the present invention, the consumer builds an improved credit rating. Similarly, the bank service provider can offer tips on how to improve your score and links to credit reporting agencies as a component of the program.

In another embodiment, the method and system of the present invention may be implemented in the form of a generic goal-oriented savings accounts for anyone. In this regard, when the account is initially established, a savings goal is set and an incentive amount is determined, access to the incentive amount is then restricted until such time as the account user approaches the set goal. Further, while the present invention is described in terms of a savings account, it is also anticipated that the method and system of the present invention is equally applicable to any other type of account including but not limited to money market accounts for high-end savers.

In another variation of the present invention, the method and system provides for enabling extended family and/or friends to contribute to the incentive accounts. Often, other family members of the bank customer express interest in assisting the bank customer in reaching their persona; goals whether it be contributing toward a grandchild's college savings or assisting in the purchase of a first home. The method and system of the present invention facilitates such participation by allowing others to make such deposits to the account for the benefit of the customer.

Still further, the customer may be provided with an online interface for the account established using the method and system of the present invention. The online interface is created in a manner that depicts the type of the account and the stated goal of the account. This allows a user to easily and readily track their progress towards the established goal as well as to get notification should they miss an agreed upon deposit thereby putting their goal in jeopardy. Similarly, the bank service provider may send e-mail alerts to notify the participants if they are behind in their monthly deposits and towards the end of the year to inform the participants of any shortfall they may have.

In yet another embodiment of the method and system of the present invention, the method provides for a bank service provider to establish a savings account for the benefit of an account holder, the account holder arranges to make periodic deposits into the savings account, further the account holder agrees to participate in at least one other service offered by the bank in return the bank service provider deposits a predetermined incentive amount into the account such that the account holder can access the incentive amount after a fixed period of time. In this regard, the other bank services may be defined as checking accounts, loan products, brokerage products, relationship accounts, money market accounts, certificates of deposit or any other parallel service offered by a banking provider.

It can therefore be seen that the present invention provides a system and method for establishing and maintaining a structured and disciplined approach to savings while providing an incentive that is sufficient to get the user excited about saving. Further, the present invention provides a method and system of administering an incentive savings account that provides a large award that is keyed to disciplined behavior on the part of customer. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A bank account that is administered by a bank service provider comprising:
a bank account at a bank service provider for the benefit of an account holder;
an initial condition within the bank account when the bank account is established for the account holder to meet; and
an incentive amount within the bank account that is predetermined when the bank account is established, wherein the account holder makes periodic deposits into the bank account and can access the incentive amount after the initial condition is met.

2. The bank account of claim 1, wherein the initial condition is a fixed period of time.

3. The bank account of claim 1, wherein the initial condition is a fixed number of deposits over a fixed period of time.

4. The bank account of claim 1, wherein the initial condition is a fixed number of deposits, each of said deposits exceeding a minimum amount.

5. The bank account of claim 1, wherein the initial condition is a fixed savings goal.

6. The bank account of claim 1, wherein the account is selected from the group consisting of: savings accounts, money market accounts, certificates of deposit, college savings vehicles, 529 plans, Coverdell savings accounts, scholarship funds, retirement vehicles, IRAs and Roth IRAs.

7. The bank account of claim 1, wherein the step of the account holder making periodic deposits into the account further comprises:
other entities making deposits into the account for the benefit of the account holder.

8. The bank account of claim 1, wherein the incentive amount is deposited when the account is established.

9. The bank account of claim 1, wherein the incentive amount is deposited after the initial condition is met.

10. The bank account of claim 1, wherein the initial condition is a plurality of periodic milestones, wherein the incentive amount is deposited when each of the plurality of milestones is met.

11. A bank account for the benefit of a child of a bank account holder, the bank account being administered by a bank service provider, comprising:
a bank account at a bank service provider for the benefit of a child of an account holder;
an initial condition within the bank account when the bank account is established for the account holder to meet; and
an incentive amount within the bank account that is predetermined when the bank account is established, wherein the account holder makes periodic deposits into the bank account and can access the incentive amount after the initial condition is met.

12. The bank account of claim 11, wherein the initial condition is making monthly deposits, each of said deposits exceeding a minimum deposit amount until the child reaches a predetermined age.

13. The bank account of claim 11, wherein the step of the account holder making periodic deposits into the account further comprises:
other entities making deposits into the account for the benefit of the account holder.

14. The bank account of claim 11, wherein the incentive amount is deposited when the account is established.

15. The bank account of claim 11, wherein a second incentive amount is deposited when the initial condition is met.

16. A bank account for accruing a down payment for a home purchase, the bank account being administered by a bank service provider, comprising:
a bank account at a bank service provider for the benefit of an account holder;
an initial condition within the bank account when the bank account is established for the account holder to meet; and
an incentive amount that is predetermined when the bank account is established, wherein the account holder makes periodic deposits into the bank account and can access the incentive amount after the initial condition is met.

17. The bank account of claim 16, wherein the initial condition is making monthly deposits, each of said deposits exceeding a minimum deposit amount until the account holder makes a home purchase.

18. The bank account of claim 16, wherein the step of the account holder making periodic deposits into the account further comprises:
other entities making deposits into the account for the benefit of the account holder.

19. The bank account of claim 16, wherein the incentive amount is credited against the loan closing costs at the closing of the home purchase.

20. The bank account of claim 16, further comprising:
prequalifying the account holder for a mortgage loan.
